(19) United States
(12) Patent Application Publication
(10) Pub. No.: US 2017/0019000 A1
(43) Pub. Date: Jan. 19, 2017

(54) ROTATING ELECTRIC MACHINE

(71) Applicant: KYB CORPORATION, Tokyo (JP)

(72) Inventors: Suguru SAKAMOTO, Kanagawa (JP); Yoshiteru KUROKAWA, Kanagawa (JP); Takayuki KAWAGUCHI, Kanagawa (JP)

(73) Assignee: KYB Corporation, Tokyo (JP)

(21) Appl. No.: 15/124,248

(22) PCT Filed: Apr. 24, 2015
(86) PCT No.: PCT/JP2015/062551

§ 371 Date: Sep. 7, 2016

(30) Foreign Application Priority Data
May 30, 2014 (JP) 2014-112038

(51) Int. Cl. H02K 11/25; H02K 15/00; G01K 1/14; H02K 5/22

(52) U.S. Cl. CPC H02K 11/25; H02K 5/225; H02K 15/0062; G01K 1/14

(57) ABSTRACT

A rotating electric machine with a stator unit having a coil wound therearound includes a busbar unit assembled with the stator unit and having a winding end part of the coil connected thereto, and a thermistor for detecting a temperature of the coil. The busbar unit includes a fixing portion for pressing and fixing the thermistor to the coil.

### TECHNICAL FIELD

The present invention relates to a rotating electric machine with a stator unit having a coil wound therearound.

### BACKGROUND ART

JP2003-83258A discloses a configuration, in which a temperature detector is fixed to the surface of a coil to detect a temperature of the coil, in a rotating electric machine with a stator unit having the coil wound therearound.

### SUMMARY OF INVENTION

However, in the case of fixing the temperature detector to the surface of the coil using an adhesive or the like, it is difficult to fix the temperature detector at a predetermined position and the temperature detector may be detached due to an adhesion failure. Thus, the position where the temperature is detected may not be stable.

The present invention aims to simply fix a temperature detector at a predetermined position of a coil and stably detect a temperature at the predetermined position of the coil.

According to one aspect of the present invention, a rotating electric machine with a stator unit having a coil wound therearound is provided. The rotating electric machine includes: a wire connection member assembled with the stator unit and having a winding end part of the coil connected thereto; and a temperature detector configured to detect a temperature of the coil. The wire connection member includes a fixing portion configured to press and fix the temperature detector to the coil.

### BRIEF DESCRIPTION OF DRAWINGS

FIG. 1 is a sectional view of a rotating electric machine according to an embodiment of the present invention,

FIG. 2 is a sectional view along line II-II of FIG. 1, and

FIG. 3 is a sectional view along line III-III of FIG. 2.

### DESCRIPTION OF EMBODIMENT

Hereinafter, an embodiment of the present invention is described with reference to the accompanying drawings.

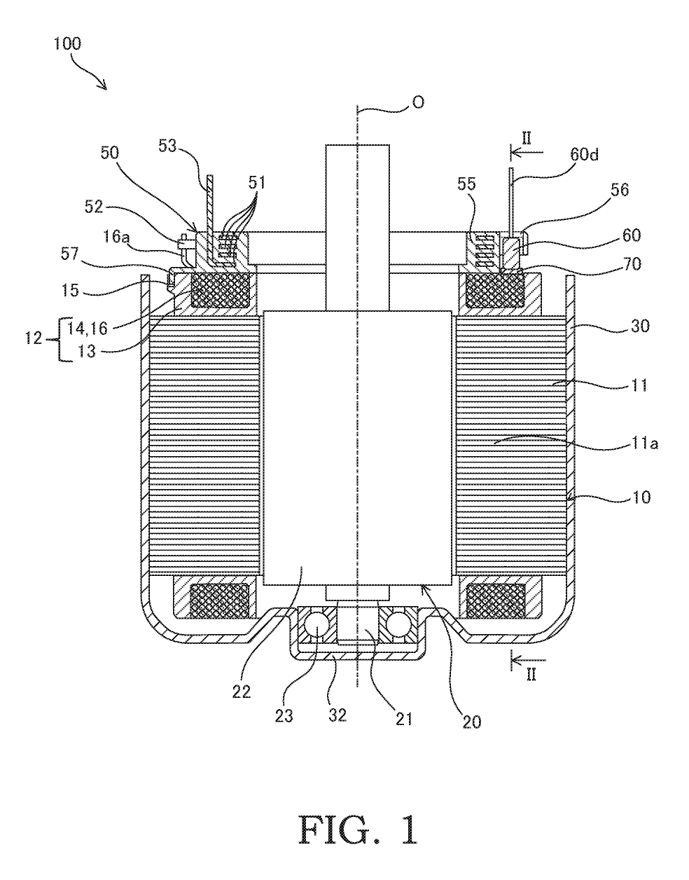

As shown in FIG. 1, a rotating electric machine 100 is a three-phase alternating-current motor and includes a stator unit 10 and a rotor 20 provided inside the stator unit 10.

The rotor 20 includes a rotor shaft 21 rotatably supported in a casing 30 and a permanent magnet 22 mounted on the rotor shaft 21.

The rotor shaft 21 has one end part supported in a bottom part 32 of the casing 30 by a bearing 23 and the other supported by a bearing provided in an unillustrated casing cover. In this way, the rotor 20 is supported rotatably about a center axis O.

The stator unit 10 includes a stator core 11 having a plurality of tooth portions 11a, a stator coil 12 provided on the tooth portions 11a of the stator core 11 and a busbar unit 50 as a wire connection member provided side by side with the stator coil 12 in an axial direction. It should be noted that the “axial direction” means an extension direction of the center axis O of the stator unit 10.

The stator core 11 is made of a magnetic material and formed by laminating a plurality of steel plates. The stator core 11 is fixed to the casing 30 by fitting the outer periphery thereof to the inner periphery of the casing 30. The plurality of tooth portions 11 a extending toward the center axis O are formed on a radially inner side of the stator core 11.

The stator coil 12 is composed of insulators 13 made of an insulating resin material and surrounding each tooth portion 1 la of the stator core 11, and coils 14 formed of wire materials 16 wound around the tooth portions 1 la via each insulator 13. The three-phase alternating-current motor 100 includes a plurality of coils 14 corresponding to a U-phase, a V-phase and a W-phase. An end part 16a of the wire material 16 of the coil 14 of each phase is pulled out from a side where the busbar unit 50 is arranged.

The busbar unit 50 includes a plurality of busbars 51 made of a conductive material and a busbar holder 55 enclosing the busbars 51.

The busbar holder 55 is formed by insert molding using an insulating resin material. Specifically, during the production of the busbar unit 50, the insulating resin material is poured into an unillustrated mold after each busbar 51 is arranged in the mold, whereby the busbar holder 55 is insert-molded.

The busbars 51 are held in the busbar holder 55 while being spaced apart in the axial direction. The busbars 51 may be held while being spaced apart in a radial direction. It should be noted that the “radial direction” means a radiation direction of the stator unit 10 with the center axis O as a center.

A number of (here, four) busbars 51 corresponding to the U-phase, the V-phase, the W-phase and a neutral point are provided. The plate-like busbar 51 corresponding to each phase includes an arcuate conducive portion (not shown) arcuately extending with the center axis 0 as a center, a plurality of power feeding terminals 52 radially projecting from the arcuate connection portion and a busbar terminal 53 axially projecting from the arcuate connection portion.

The end part 16a of the wire material 16 pulled out from the coil 14 of each phase is connected to the power feeding terminals 52 projecting from the outer periphery of the busbar holder 55. The busbar terminals 53 are connected to an unillustrated alternating-current power supply and project to the outside of the busbar holder 55 from the respective busbars 51 corresponding to the U-phase, the V-phase and the W-phase. In this way, the coil 14 of each phase is Y-connected to the alternating-current power supply. It should be noted that the coil 14 of each phase may be 4-connected instead of being Y-connected.

The busbar holder 55 includes a plurality of positioning portions 57 projecting from an outer peripheral end of the busbar holder 55 and to be engaged with the outer periphery of the stator coil 12. On the other hand, a plurality of engaging portions 15 to be engaged with the positioning portions 57 are formed on the outer peripheries of the insulators 13 of the stator coil 12. In the present embodiment, the positioning portions 57 and the engaging portions 15 are snap-fitted. By engaging the positioning portions 57 with the engaging portions 15, the busbar holder 55 is fixed to the stator coil 12. In this way, the end part 16a of the wire material 16 of each coil 14 is positioned in proximity to the power feeding terminals 52 of each busbar 51. Any connection structure of the positioning portions 57 and the engaging portions 15 may be adopted without being limited to snap-fitting if the busbar holder 55 can be fixed to the stator coil 12. Further, the engaging portions 15 may be provided on the stator core 11 instead of on the insulators 13.

The rotating electric machine 100 further includes a thermistor 60 as a temperature detector for detecting a temperature of the coil 14 and a heat transfer material 70 interposed between the thermistor 60 and the coil 14. The thermistor 60 is connected to an unillustrated control device of the rotating electric machine 100 via a lead wire 60d. The control device controls the drive of the rotating electric machine 100 on the basis of a detection value of the thermistor 60 such as by limiting the operation of the rotating electric machine 100 if the temperature of the coil 14 detected by the thermistor 60 is high. The thermistor 60 is fixed by a fixing portion 56 formed on the busbar holder 55.

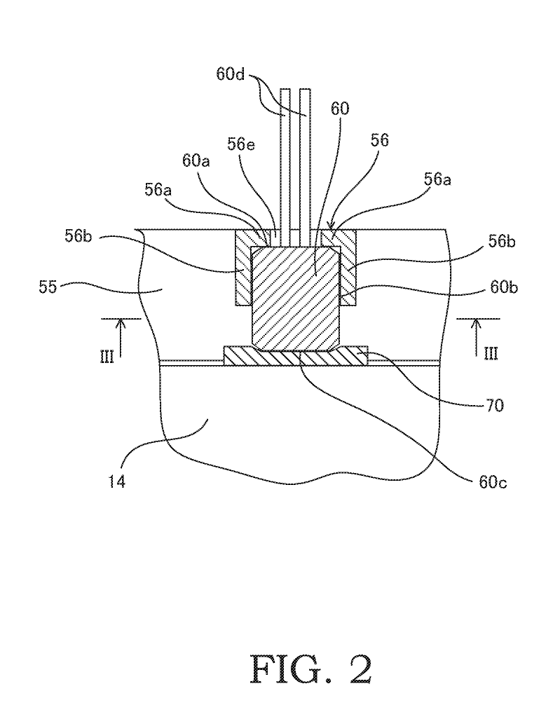

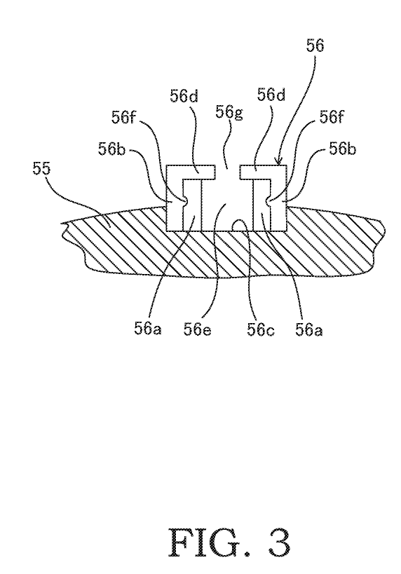

Next, the fixation of the thermistor 60 by the fixing portion 56 is described with reference to FIGS. 2 and 3. FIG. 2 is a sectional view along line II-II of FIG. 1 enlargedly showing the periphery of the thermistor 60. FIG. 3 is a sectional view along line III-III of FIG. 2 showing the shape of the fixing portion 56 with the thermistor 60 omitted.

As shown in FIGS. 2 and 3, the fixing portion 56 includes a pressing piece 56a held in contact with a shoulder surface 60a of the thermistor 60, gripping pieces 56b for gripping side surfaces 60b of the thermistor 60, an inner peripheral side positioning wall 56c for positioning a radially inner side of the thermistor 60 and an outer peripheral side positioning wall 56d for positioning a radially outer side of the thermistor 60.

The pressing piece 56a extends radially outward from the busbar holder 55. A surface of the pressing piece 56a held in contact with the thermistor 60 on the side of the coil 14 is formed into a flat surface in conformity with the shape of the shoulder surface 60a of the thermistor 60. Further, a cut 56e through which the lead wire 60d of the thermistor 60 is passed is provided to penetrate through a central part of the pressing piece 56a in the axial direction.

The gripping pieces 56b extend parallel to each other toward the coil 14 from opposite circumferential ends of the pressing piece 56a. As shown in FIG. 3, projections 56f projecting toward the side surfaces 60b of the thermistor 60 are formed on the inner surfaces of the gripping pieces 56b. The projections 56f may have any shape if the thermistor 60 can be gripped by narrowing an interval between the facing gripping pieces 56b. Further, the projections 56f may be provided on the side surfaces 60b of the thermistor 60.

The inner peripheral side positioning wall 56c couples base end parts of the pressing piece 56a and the gripping pieces 56b on the side of the busbar holder 55. In the present embodiment, the inner peripheral side positioning wall 56c is configured by a part of the outer peripheral surface of the busbar holder 55. The outer peripheral side positioning wall 56b is formed in parallel to the inner peripheral side positioning wall 56c and couples radially outer end parts of the pressing piece 56a and the gripping pieces 56b. A slit 56g for guiding the lead wire 60d of the thermistor 60 to the cut 56e of the pressing piece 56a is provided in a central part of the outer peripheral side positioning wall 56d. This slit 56g may not be provided if the cut 56e has a size enabling the passage of an unillustrated connector or the like provided on the tip of the lead wire 60d.

The inner peripheral side positioning wall 56c regulates a radially inward movement of the thermistor 60 and the outer peripheral side positioning wall 56d regulates a radially outward movement of the thermistor 60. In this way, a fixed position of the thermistor 60 in the radial direction is determined. Positions where the inner peripheral side positioning wall 56c and the outer peripheral side positioning wall 56d are formed are so set that the thermistor 60 is arranged at a temperature measurement point on the coil 14.

As shown in FIG. 3, the fixing portion 56 is partly formed inside the busbar holder 55. Since the power feeding terminals 52 and the busbar terminals 53 are arranged on an outer peripheral side of the busbar holder 55, the fixing portion 56 is formed while avoiding positions where these are arranged. Without limitation to the above configuration, the fixing portion 56 may be provided to radially outwardly project from the busbar holder 55 or may be entirely provided inside the busbar holder 55. Further, although the fixing portion 56 is integrally formed with the busbar holder 55 in the present embodiment, the fixing portion 56 having the above configuration may be formed by a member separate from the busbar holder 55 and connected to the busbar holder 55 such as by being press-fitted or snap-fitted. Alternatively, only a part of the fixing portion 56, e.g. the pressing piece 56a may be formed of a separate member and connected to the busbar holder 55.

The heat transfer material 70 is formed of thermally conductive and elastic silicone resin or the like and functions as a cushioning material for transferring heat of the coil 14 to the thermistor 60 and preventing a measurement surface 60c of the thermistor 60 and the surface of the coil 14 from directly coming into contact. If the thermistor 60 is formed such as of a material that is not damaged even if coming into contact with the coil 14, the heat transfer material 70 may not be provided.

Next, a procedure of fixing the thermistor 60 is described.

First, the lead wire 60d of the thermistor 60 is passed through the cut 56e of the fixing portion 56. In this state, the thermistor 60 is inserted into a space enclosed by the gripping pieces 56b, the inner peripheral side positioning wall 56c and the outer peripheral side positioning wall 56d with the shoulder surface 60a thereof caused to face the pressing piece 56a of the fixing portion 56 until the shoulder surface 60a and the pressing piece 56a come into contact. The thermistor 60 inserted into between the gripping pieces 56b is held in the fixing portion 56 by the projections 56f of the gripping pieces 56b, whereby detachment from the fixing portion 56 is prevented. Next, the heat transfer material 70 is fixed to the measurement surface 60c of the thermistor 60 or the surface of the coil 14 by an adhesive or the like. Subsequently, the positioning portions 57 of the busbar unit 50 are assembled with the engaging portions 15 of the stator coil 12 by snap-fitting. At this time, the end part 16a of the wire material 16 of each coil 14 is pulled out from a clearance of the insulator 13 and the busbar holder 55 and is welded to the power feeding terminals 52 of each busbar 51.

At the same time as the positioning portions 57 of the busbar unit 50 are assembled with the engaging portions 15 of the stator coil 12 by snap-fitting, the thermistor 60 is pressed toward the coil 14 by the pressing piece 56a of the fixing portion 56 and pressed against the elastic heat transfer material 70. As a result, the thermistor 60 is sandwiched by the pressing piece 56a and the heat transfer material 70, radial movements thereof are regulated by the inner peripheral side positioning wall 56c and the outer peripheral side positioning wall 56d and circumferential movements are regulated by the gripping pieces 56b, whereby the thermistor 60 is fixed at a predetermined position on the coil 14. In this way, the thermistor 60 is fixed simultaneously with the assembling of the stator coil 12 with the busbar unit 50.

According to the above embodiment, the following effects are exhibited.

The thermistor 60 is gripped by the gripping pieces 56b of the fixing portion 56 of the busbar holder 55 and sandwiched by the pressing piece 56a of the fixing portion 56 and the heat transfer material 70. Thus, the thermistor 60 is fixed at the predetermined position of the coil 14 and can stably detect a temperature at the predetermined position. Further, as compared to the case where an adhesive is used, the thermistor 60 can be prevented from being detached or coming out due to vibration.

Further, the fixation of the thermistor 60 is completed only by inserting the thermistor 60 into between the gripping pieces 56b of the fixing portion 56 of the busbar holder 55 and assembling the busbar unit 55 with the stator coil 12. Thus, the thermistor 60 is simply fixed and production cost can be reduced as compared to the case where the adhesive is used since an adhesion step and an adhesive drying step are not necessary.

Further, the position where the thermistor 60 is fixed is uniquely determined by the position of the fixing portion 56 formed on the busbar holder 55. Thus, a variation of the fixed position of the thermistor 60 can be prevented as compared to the case where the adhesive is used. Further, the fixed position of the thermistor 60 can be changed to a desired position only by changing the position of the fixing portion 56.

Further, the fixing portion 56 is partly formed inside the busbar holder 55. Thus, the busbar unit 50 including the fixing portion 56 can be formed compact.

Embodiments of the present invention were described above, but the above embodiments are merely examples of applications of the present invention, and the technical scope of the present invention is not limited to the specific constitutions of the above embodiments.

For example, although the busbar unit 50 is illustrated as the wire connection member in the present embodiment, the wire connection member may have any configuration if it is a member structured such that the end part 16a of the wire material 16 of each coil 14 is connected thereto such as a printed circuit board. Further, the wire connection member may include a holder made of resin and having a groove portion, and a plurality of busbars held in the groove portion of the holder.

Further, although the thermistor 60 and the heat transfer material 70 are arranged on the surface of one coil 14 in the present embodiment, they may be arranged over the surfaces of two adjacent coils 14. In this case, the thermistor 60 can detect the temperature of each of the two coils 14.

Further, although the rotating electric machine 100 is a three-phase alternating-current motor in the present embodiment, it may be any rotating electric machine of a type in which a wire connection member is arranged adjacent to a coil.

This application claims priority based on Japanese Patent Application No. 2014-112038 filed with the Japan Patent Office on May 30, 2014, the entire contents of which are incorporated into this specification.

1. A rotating electric machine with a stator unit having a coil wound therearound, comprising:
a wire connection member assembled with the stator unit and having a winding end part of the coil connected thereto; and
a temperature detector configured to detect a temperature of the coil, wherein:
the wire connection member includes a fixing portion configured to press and fix the temperature detector to the coil.

2. The rotating electric machine according to claim 1, further comprising a heat transfer material interposed between the coil and the temperature detector, wherein:
the heat transfer material has elasticity.

3. The rotating electric machine according to claim 1, wherein:
the fixing portion includes a gripping piece configured to grip a side surface of the temperature detector.

4. The rotating electric machine according to claim 3, wherein:
the gripping piece includes a projection that projects toward the side surface of the temperature detector.

5. The rotating electric machine according to claim 1, wherein:
the fixing portion is integrally formed on an outer periphery of the wire connection member.

6. The rotating electric machine according to claim 1, wherein:
the wire connection member includes a positioning portion configured to be engaged with the stator unit; and
the temperature detector is pressed and fixed at the same time as the wire connection member is engaged with the stator unit.
